(19) United States
(12) Patent Application Publication
(10) Pub. No.: US 2008/0277949 A1
(43) Pub. Date: Nov. 13, 2008

(54) Safety Door Stop

(76) Inventors: Christopher Emde, Bloomfield Hills, MI (US); Marina Emde, Bloomfield Hills, MI (US)

Correspondence Address: YOUNG & BASILE, P.C., 3001 WEST BIG BEAVER ROAD, SUITE 624, TROY, MI, 48084, US

(21) Appl. No.: 12/114,240

(22) Filed: May 2, 2008

Related U.S. Application Data
(60) Provisional application No. 60/916,020, filed on May 4, 2007.

(51) Int. Cl. E05C 17/44

(52) U.S. Cl. 292/343

(57) ABSTRACT

A safety doorstop device comprising a first pair of recessed walls configured to be joined at one end so that an inner cut angle is formed between the pair of recessed walls; and a doorstop body configured to incorporate the first pair of recessed walls so that a gap formed between a hinged edge of an open door and a door jamb is supported by the doorstop body such that at least one recessed wall contacts at least one of the hinged edge of the open door, the inner edge of the door jamb, and the inner edge of the door frame.

### CROSS-REFERENCE TO RELATED APPLICATION

This application claims priority from U.S. Provisional Application Serial No. 60/916,020 filed May 4, 2007, which is hereby incorporated by reference in its entirety.

### FIELD OF THE INVENTION

The invention relates to doorstops generically, and particularly to doorstops disposed between a hinged edge of a door and a door jamb for maintaining the door in an open position.

### BACKGROUND

It is desirable to maintain doors in an open position for a variety of reasons. Situations requiring an open door can include room cleanings in public or private buildings, moving furniture into and out of rooms, and for child safety. Various designs of doorstops are known. It would be desirable to have an improved doorstop that is inexpensive and easy to construct, as well as useful for protecting children from pinching fingers in closing doors.

### SUMMARY

A safety door arrangement is disclosed including a door pivotally mounted to a door jamb by at least one hinge to permit the door to open and close. The door is in an open position so that the door and the door jamb define a gap therebetween having a varying distance that is at a minimum near the hinge. A removable doorstop is inserted into the gap to prevent the door from moving. The removable doorstop is positioned in the gap and has an intermediate portion with an upwardly facing top and a downwardly facing bottom defining therebetween a thickness that does not exceed the minimum distance of the gap. The doorstop also includes a first end and a second end projecting from opposite lateral sides of the intermediate portion. Each of the first end and second end has a width that is substantially greater than the minimum distance of the gap, and is further sized and configured to fit snugly between the door and the door jamb. The first end is interposed between the door and the door jamb to prevent the door from closing. The second end is interposed between the door and the door jamb to prevent the door from opening.

In other embodiments, a removable doorstop is provided for use in holding open a door that is pivotally mounted to a door jamb by at least one hinge, in which the door and the door jamb define a gap therebetween when the door is fully opened. The doorstop includes an intermediate portion having an upwardly facing top and a downwardly facing bottom defining therebetween a thickness along a first dimension that does not exceed a distance of the gap when the door is open; wherein the intermediate portion is sized and configured to pass through the gap when the doorstop is positioned with the top and bottom facing sideways. The doorstop also includes a first end and a second end projecting from opposite lateral sides of the intermediate portion. Each of the first end and second end having a width substantially greater than the minimum distance of the gap. The first and second ends are further sized and configured to fit snugly between the door and the door jamb on opposing sides of the hinge.

In other embodiments, a method is provided for safely holding a door in a fixed position. The method includes opening a door pivotally mounted to a door jamb by a hinge, so that a gap opens between the door and the door jamb; and providing a removable doorstop having a top surface and a bottom surface defining therebetween a thickness along a first dimension that does not exceed the distance of the gap at its most narrow point. The doorstop has a first end portion with a width along a second dimension that is slightly greater than the distance of at least a portion of the gap. The method also includes holding the doorstop at a first orientation so that the top and bottom are facing sideways and then inserting the doorstop into the gap. Finally, the doorstop is rotated to engage the first end portion between the door and the door jamb in a friction fit, wherein the first end portion is positioned to prevent the door from moving to a closed position.

### BRIEF DESCRIPTION OF THE DRAWINGS

The description herein makes reference to the accompanying drawings wherein like reference numerals refer to like parts throughout the several views, and wherein:

FIG. 1 is a perspective view of a first embodiment of the doorstop device according to the present invention;

FIG. 1A is a perspective view of a door assembly in which the doorstop shown in FIG. 1 is used to hold open the door;

FIG. 1B is a sectional view of the door assembly of FIG. 1A, taken along the lines 1B-1B′;

FIG. 2 is a side view of the doorstop shown in FIG. 1;

FIG. 3 is a perspective view of another embodiment of the invention;

FIG. 4 is a perspective view of yet another embodiment of the invention;

FIG. 5 is a perspective view of yet another embodiment of the invention;

FIG. 6 is a top plane view of the doorstop shown in FIG. 5 inserted into a door assembly, which is shown in sectional view; and

FIG. 7 is a side view of the doorstop shown in FIG. 5.

### DETAILED DESCRIPTION

As explained below with reference to the drawings, a safety door arrangement is disclosed in which a door is pivotally mounted to a door jamb by at least one hinge to permit the door to open and close. Typically, the door will include three hinges—a bottom, middle and top hinge—that are spaced at regular intervals along the vertical extent of the door. When the door is in an open position (including a fully opened position in which the door is roughly at an angle of 75 to 90 degrees relative to its fully closed position), the door and the door jamb define a gap. The lateral or hinged side edge of the door can have a thickness of approximately one to three inches. Measuring along this side edge, the gap varies in distance and is typically at a minimum near the hinge. Although for convenience the term “door jamb” is used herein, it should be understood that it is meant to encompass a frame or other structure against which the hinged edge of the door abuts.

A removable doorstop is inserted into the gap to prevent the door from closing. The doorstop has an upwardly facing top and a downwardly facing bottom defining between them a thickness that does not exceed the minimum distance of the gap (such as for example 0.5 to 0.75 inches). As explained below, this thickness is selected to permit the doorstop to be inserted into the gap when oriented so that the top and bottom each face sideways. The doorstop can be a unitary body or can be made of two or more components that are bonded, laminated, snapped, welded, fastened or otherwise joined together. It can include an intermediate portion which can pass through the gap so that it straddles the hinges or the axis defined by the hinges. Two end portions extend from opposing sides of the intermediate portion, and each of the end portions has a width (e.g. 1.5 to 3 inches) that is substantially greater than the minimum distance of the gap, while having a thickness that is less than the minimum distance.

The two ends are shaped and sized to fit snugly between the door and the jamb, which typically are perpendicular to each other when the door is fully opened. It will be appreciated that since the doorstop is inserted through the gap, one of the ends is on the inside of the doorway and the other extends through the gap to the outside of the doorway. In this manner, one of the ends can be interposed between the door and the door jamb to prevent the door from closing; and the other end can be interposed between the door and the door jamb to prevent the door from opening. By selecting an appropriate size and shape for each end portion (such as rectilinear boxes approximately 1.5 inches by 1.5 inches by 0.75 inches), the end portions can be wedged into position and held in place by friction fit between the door and the door jamb. The doorstops may be made of any desirable materials such as an elastomeric material, which can be under compression when the doorstop is inserted into the gap.

To use the doorstop, the door is opened, for example, to its full opened position. The doorstop is grasped by the user and oriented so the top and bottom face sideways. This minimizes the horizontal projection of the doorstop and permits the doorstop to be inserted into and through the gap between the door and the door jam, so that one end portion projects on the inside of the doorway and the other projects through the gap to the outside of the doorway. The doorstop is then rotated (e.g. 90 degrees), squeezing, wedging, lodging or otherwise placing the two end portions into snug engagement between the door and the door jam. Use of elastomeric material may facilitate the rotation of the end portions in snug, friction fit engagement between the door and the door jamb.

One use of a doorstop is to hold open a door so that small children do not pinch their fingers in the gap between the door and the door jamb. To improve the effectiveness of a doorstop in this application, it is helpful to place the doorstop out of reach of small children. Otherwise, small children may remove the doorstop, causing the door to close on their fingers or other body parts.

Because the doorstop can be held in place by friction fit between the door and the door jamb, the doorstop can be suspended off the ground and off the hinges, in contrast to some existing devices which require installation in association with a hinge. This enables the disclosed doorstop to be located at a convenient position that is too high for most small children to reach, but low enough for easy installation by most adults. For example, the typical residential door is between seven and eight feet and has three hinges—bottom, middle and top. The bottom hinge is less than one foot off the ground, easily within reach of a small child. The middle hinge is also typically less than 4 feet off the ground, still within reach of a child under the age of five. The top hinge is often in excess of six feet, out of reach of children but also uncomfortably high for many adults. Thus, if a doorstop is placed on a hinge, it is difficult to place the doorstop high enough to avoid tampering by small children. The disclosed doorstop, because it can be affixed to the door by friction fit, can be located at a more convenient height such as between four and five feet, for example. (According to the National Center of Health Statistics, 95% of boys under five years of age are less than 48 inches tall).

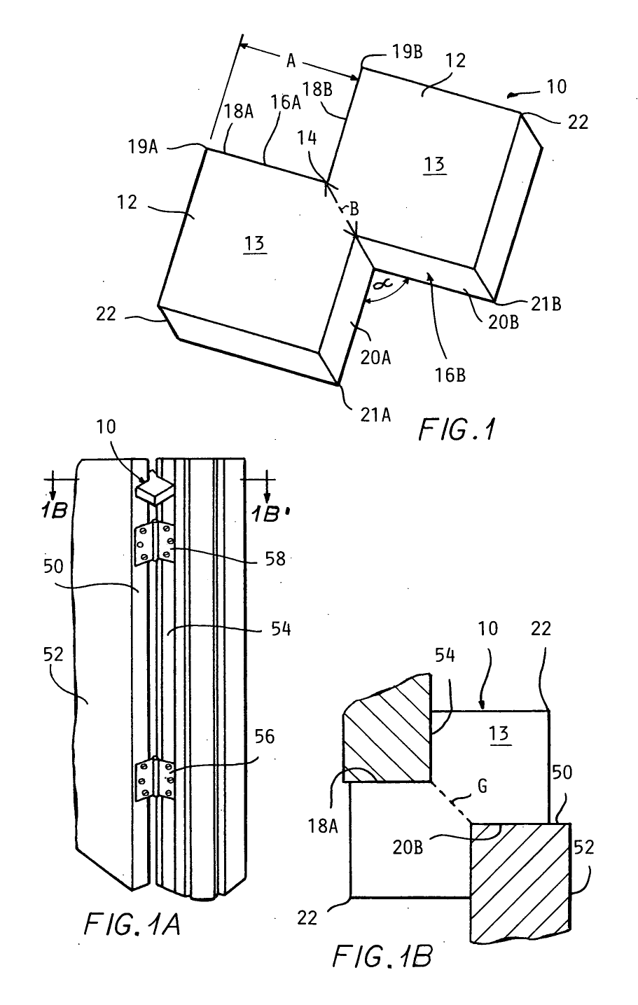

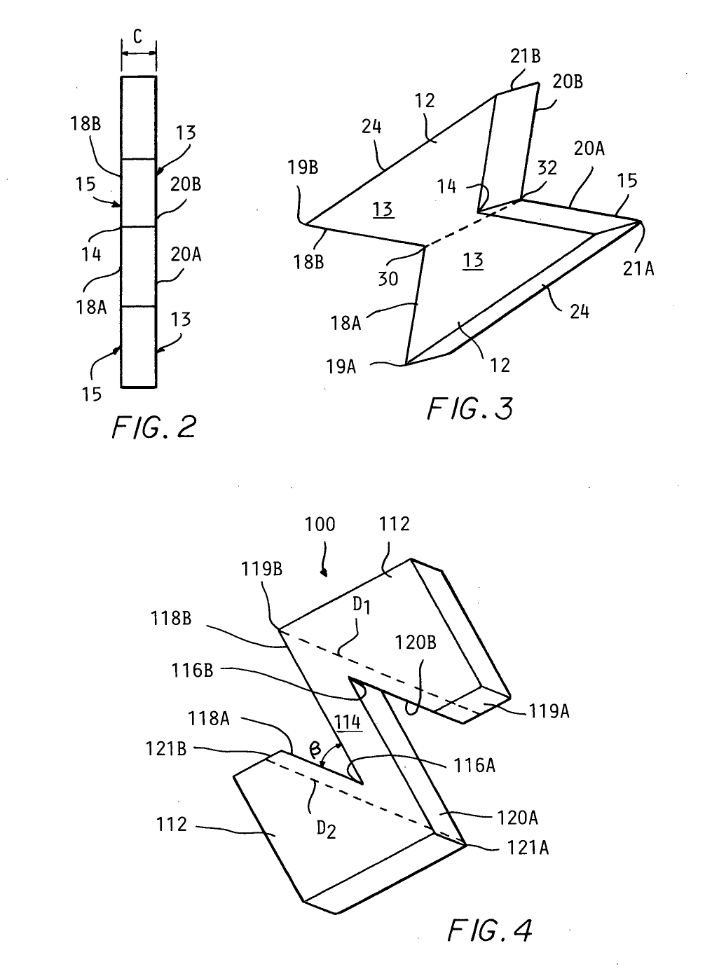

Referring to FIGS. 1, 1A, 1B and 2, a safety doorstop device 10 provides a unitary body that fits between the hinged edge 50 of an installed door 52 and the door jamb 54 to prevent the door 52 from closing. The door has a bottom hinge 56, a middle hinge 58 and a top hinge (not shown). The doorstop device 10 is located in this example above middle hinge 58 at a height of 56 inches. Alternatively, the doorstop can be placed at any other position along the vertical extent of the gap, including adjacent to one of the hinges. A gap is formed between door jam 54 and door 52. The distance of the gap varies along the hinged edge 50, but is at a minimum near the hinge, as represented by dotted line G in FIG. 1B.

The safety doorstop device 10 is a block having a pair of expanded end portions 12 forming opposing parallel faces 13, 15 separated by an intermediate or reduced portion 14. The unitary block can be made with a rugged material that is resistant to permanent deformation. The material is able to withstand temporary distortion and able to regain its shape once a force is removed. As examples only, a high impact injection molded plastic, foam or rubber would be suitable materials since they are durable materials having relatively low manufacturing costs. Use of a resilient deformable material can facilitate the placement of end portions 12 between the door 52 and the door jamb 54.

The intermediate portion 14 has a width B that is smaller than the gap formed between the hinged edge 50 of the open door 52 and the door jamb 54, or alternatively, an inner edge of the door frame. The door stop device 10 can have a uniform thickness C that is less than the minimum distance G of the gap between the hinged edge 50 of door 52 and the door jamb 54.

In one embodiment shown in FIG. 1, a pair of opposing inner cuts 16A, 16B is each formed by a pair of recessed walls 18A, 18B and 20A, 20B, respectively. Each pair of recessed walls 18A, 18B and 20A, 20B forms the inner cuts 16A, 16B, respectfully. The inner cuts 16A, 16B each form an angle (α), which is preferably greater than or equal to about 90 degrees and preferably, less than about 135 degrees between their respective recessed walls. While this is a preferred range for (α), the angle may be less than 90 degrees and greater than 135 degrees. The angles (α) of the inner cuts 16A, 16B allow at least one recessed wall 18A, 18B, 20A or 20B to be in contact with either the hinged edge 50 of the door 52 or the door jamb 54, when the doorstop device 10 is installed. The recessed walls 18A, 18B, 20A and 20B each terminate at an apex 19A, 19B, 21 A and 21 B, respectively. The recessed walls have a length A extending from the reduced portion 14 to the apex 19A, 19B, 21A or 211B, that allow for frictional contact against the door 52 and/or inner door jamb 54. The length A is less than or equal to the thickness of the door 52 to fit within the outer edge of the door jamb 54. The recessed walls 18A, 18B and 20A, 20B provide substance to the door stop device 10, so that when the device is installed between a door 52 and its associated door jamb 54, the door stop device 10 cannot easily rotate to disengage from its position.

The safety doorstop device 10 is installed between a hinged door edge 50 and a door jamb 54 by orientating the doorstop device 10, so that the faces 13, 15 are parallel to the hinged door edge 50 and the door jamb 54—that is, facing horizontally or sideways. The door stop device 10 can be installed between the door 52 and door jamb 54 leading with one of the leading edges 22 and 24, or the apexes 19A, 19B, 21A and 21B. When the intermediate portion 14 is positioned between the door and the door jamb, the doorstop device 10 is rotated 90°, so that the intermediate portion 14 sits laterally between the door and the door jamb, and the faces 13, 15 of the doorstop device 10 are essentially parallel with the ceiling and floor of the room. Alternatively, in some embodiments, faces 13, 15 are not planar.

In order to allow for the rotation of the doorstop device 10 between the hinged door edge 50 and the door jamb 54, the horizontal projection of reduced portion (see FIG. 1) can be less than the minimum distance G between the opened hinged door edge 50 and the door jamb 54, when the faces 13, 15 are orientated 45° relative to the floor or ceiling (which is when the horizontal projection of reduced portion is greatest).

Once the faces 13, 15 of the doorstop device 10 are orientated parallel to the floor and ceiling, the safety doorstop device 10 is secured in place. The safety doorstop 10 is held in place frictionally when at least one recessed wall 18A, 18B, 20A or 20B frictionally grips an edge of the hinged door edge or door jamb. As an alternative or addition, the doorstop device 10 is held in place between the door and door jamb with the intermediate portion 14 resting on an associated door hinge. The expanded end portions 12 prevent the installed doorstop device 10 from slipping out of the gap between the door edge and the door jamb.

The contact points of the door and the door jamb onto the recessed walls 18A, 18B, 20A and 20B determine the amount of closure of the door allowed by the doorstop device 10. The amount of closure can vary depending on the hinge size and the angle ca of the inner cuts 16A, 16B.

The shape of the first embodiment of the doorstop device may vary as shown in FIGS. 1 and 3. Although each of the bodies will have an intermediate portion 14 disposed between a pair of expanded end portions 12, the expanded end portions 12 may be mirror images of each other. However, the expanded end portions 12 may also have different dimensions or configurations from each other. The leading edges 22 of the doorstop device 10 may be angular and pointed as shown in FIG. 1, or planar as shown in FIG. 3 at 24. As a further alternative, the leading edge may be concave or actuate. Other configurations are possible for the leading edges.

Another embodiment of the safety doorstop device 100 is shown in FIG. 4, wherein the inner cuts 116A, 116B are positioned offset from each other. The inner cuts 116A, 116B are formed by a pair of recessed walls 118A, 118B and 120A, 120B, respectively. The offset inner cuts provide a reduced portion 114 therebetween formed between recessed walls 118B and 120A. The inner cuts 116A, 116B form the transition between the reduced portion and the expanded end portions 112. Inner cut 116A, 1161B can be at an acute angle (β). Angle β, together with the length of the reduced portion 114, allows for rotational clearance of the doorstop device 100 when the device 100 is being installed or removed between the door and door jamb.

The frictional points on the doorstop device 100 in the second embodiment include areas 119B and 121A and edges 119A and 121B. The frictional points are the points of contact of the device 100 with the door edge surface and the inner door jamb surface, and also with a portion of the planar door surface and the outer door jamb. Therefore, the distance D1 between frictional points 119A and 119B and the distance D2 between frictional points 121A and 121 B is configured for positioning between the open door and door jamb.

It is evident that depending on the installation of the doorstop device 100, the points of contact (frictional points) of the device 100, may be slightly offset from areas 119B and 121A; and further that the points of contact may be along any portion of edges 119A and 1211B.

In another configuration of FIG. 4, the device 100 may be configured so that walls 118A and 120B terminate at a point (not shown), so that edges 121B and 119A, respectively, are a point rather than a planar surface.

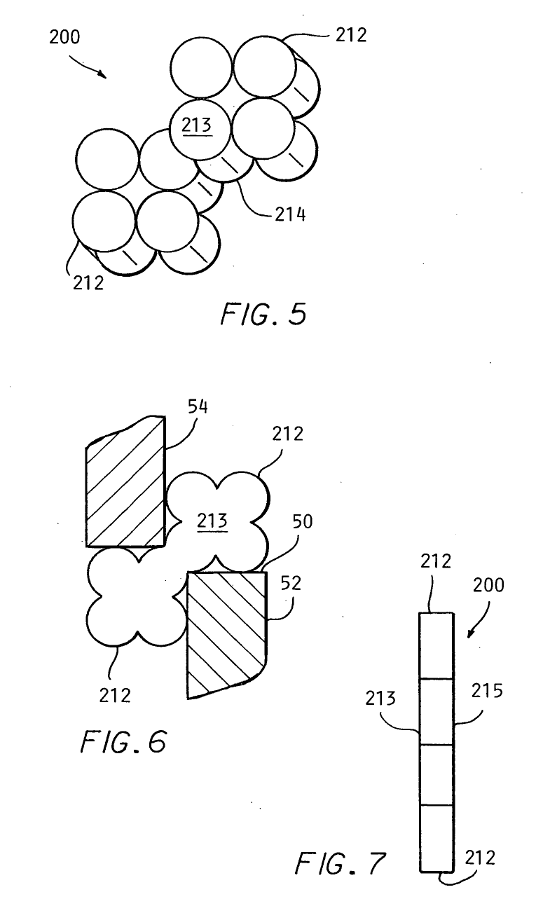

Referring to FIGS. 5-7, another embodiment is illustrated in the form of doorstop 200. Doorstop 200 functions in a manner similar to the foregoing embodiments, but is composed of multiple conjoined semi-cylindrical bodies that define two expanded end portions 212, forming opposing parallel faces 213, 215 separated by a reduced portion 214.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law. For example, and without limiting the generality of the foregoing, the dimensions and angles specified above are for purposes of illustration and different dimensions and angles can be used in different applications.

What is claimed is:

1. A safety door arrangement, comprising:
a door pivotally mounted to a door jamb by at least one hinge to permit the door to open and close;
the door being in an open position so that the door and the door jamb define a gap therebetween having a varying distance that is at a minimum near the hinge;
a removable doorstop inserted into the gap to prevent the door from moving, the removable doorstop having an intermediate portion with an upwardly facing top and a downwardly facing bottom defining therebetween a thickness that does not exceed the minimum distance of the gap;
a first end and a second end projecting from opposite lateral sides of the intermediate portion, each of the first end and second end having a width substantially greater than the minimum distance of the gap, and further sized and configured to fit snugly between the door and the door jamb; and
wherein the first end is interposed between the door and the door jamb to prevent the door from closing; and the second end is interposed between the door and the door jamb to prevent the door from opening.

2. The safety door arrangement of claim 1, wherein the doorstop is elastomeric and sized and configured so that the first end and second end are each compressed between the door and the door jamb.

3. The safety door arrangement of claim 1, wherein each of the first and second ends has a first lateral side configured to engage the door and a second lateral side configured to engage the door jamb.

4. The safety door arrangement of claim 3, wherein the door is opened so that a hinged end of the door is perpendicular to an inner edge of the door jamb.

5. The safety door arrangement of claim 3, wherein for at least one of the first end and the second end, the first lateral side and the second lateral side are perpendicular to each other.

6. The safety door arrangement of claim 1, wherein for at least one of the first end and the second end, the first lateral side is one of linear, concave and actuate.

7. The safety door arrangement of claim 1, wherein at least a portion of the first end is composed of a plurality of conjoined semi-cylindrical bodies.

8. The safety door arrangement of claim 7, wherein the cylindrical bodies form a plurality of engagement surfaces for contacting at least one of the door and the door jamb.

9. The safety door arrangement of claim 1, wherein the doorstop is spaced apart from the hinge.

10. The safety door arrangement of claim 9, wherein the doorstop is located at a height of at least 48″ as measured from the floor.

11. A doorstop for use in holding a door pivotally mounted to a door jamb by at least one hinge to permit the door to open and close, wherein the door and the door jamb define a gap therebetween when the door is opened, comprising:
an intermediate portion having an upwardly facing top and a downwardly facing bottom defining therebetween a thickness along a first dimension that does not exceed the distance of the gap when the door is open; wherein the intermediate portion sized and configured to pass through the gap when the doorstop is positioned with the top and bottom facing sideways;
a first end and a second end projecting from opposite lateral sides of the intermediate portion, each of the first end and second end having a width substantially greater than the minimum distance of the gap, and further sized and configured to fit snugly between the door and the door jamb on opposing sides of the hinge.

12. The doorstop of claim 11, further comprising two pairs of recessed walls, each pair of recessed walls configured to be joined at the intermediate portion end so that an inner cut angle is formed between the pair of recessed walls.

13. The doorstop of claim 11, wherein the doorstop is elastomeric and sized and configured so that the first end and second end are each compressed between the door and the door jamb when the doorstop is inserted into the gap and rotated.

14. The doorstop of claim 11, wherein each of the first end and second end has a first lateral side configured to engage the door and a second lateral side configured to engage the door jamb.

15. The doorstop of claim 14, wherein for at least one of the-first end and the second end, the first lateral side and second lateral side are perpendicular to each other.

16. The doorstop of claim 14, wherein for at least one of the first end and the second end, the first lateral side and second lateral side form an acute angle.

17. The doorstop of claim 11, wherein at least a portion of the first end is made of a plurality of conjoined semi-cylindrical bodies.

18. A method for safely holding a door in a fixed position, comprising:
opening a door pivotally mounted to a door jamb by a hinge, so that a gap opens between the door and the door jamb;
providing a removable doorstop having a top surface and a bottom surface defining therebetween a thickness along a first dimension that does not exceed the distance of the gap at its most narrow point, and having a first end portion with a width along a second dimension that is at least slightly greater than the distance of at least a portion of the gap;
holding the doorstop at a first orientation so that the top and bottom are facing sideways;
inserting the doorstop into the gap; and
rotating the doorstop to engage the first end portion between the door and the door jamb in a friction fit, wherein the first end portion is positioned to prevent the door from moving to a closed position.

19. The method of claim 18, wherein the doorstop is inserted into the gap at least 48″ above the floor.

20. The method of claim 18, further comprising:
providing a removable doorstop having a second end projecting from the intermediate portion on the opposite lateral side as the first end, each of the first end and second end having a width substantially greater than the minimum distance of the gap, and further sized and configured to fit snugly between the door and the door jamb; and
rotating the doorstop to engage the first end and the second end between the door and the door jam.
